(19) United States
(12) Patent Application Publication
(10) Pub. No.: US 2011/0286036 A1
(43) Pub. Date: Nov. 24, 2011

(54) INFORMATION PROCESSING APPARATUS, PRINT CONTROL PROGRAM, AND RECORDING MEDIUM

(76) Inventor: Hiroto KOBAYASHI, Saitama (JP)

(21) Appl. No.: 13/086,732

(22) Filed: Apr. 14, 2011

(30) Foreign Application Priority Data
May 18, 2010 (JP) 2010-114465

(51) Int. Cl. G06K 15/02

(52) U.S. Cl. 358/1.15

(57) ABSTRACT

An information processing apparatus of the present invention includes an obtaining unit; a receiving unit; a generating unit; and an output unit that outputs to the printer the command generated for each of the request. The obtaining unit obtains a specification of commands to output to a printer; the receiving unit receives a request for a process to be executed for the printer; the generating unit generates a predetermined command corresponding to a type of the request and the specification obtained when the request is received; and the output unit outputs to the printer the command generated for each of the request.

### CROSS-REFERENCE TO RELATED APPLICATIONS

The present application claims priority to and incorporates by reference the entire contents of Japanese Patent Application No. 2010-114465 filed in Japan on May 18, 2010.

### BACKGROUND OF THE INVENTION

1. Field of the Invention

The present invention relates to an information processing apparatus, a print control program, and a recording medium.

2. Description of the Related Art

When a computer makes a printer print, the computer uses a printer driver to generate a plurality of types of commands and send them to the printer. There are several types of commands such as drawing commands including commands to draw texts, images, graphics, or the like and job commands including commands for print settings such as duplex printing, stapling, or the like. In addition, a plurality of specifications are available for each type of commands. For example, the drawing commands (page description language (PDL)) include printer control language (PCL), and the job commands include print job language (PJL) and job definition format (JDF). The printer driver converts such multiple commands into respective description languages that are readable by the printer.

Conventionally, in the development of printer drivers, one printer driver is developed in a structure corresponding to one printer description language and thus, a number of printer drivers have been developed for the same number of printer description languages available. However, developing the printer drivers corresponding to the number of printer description languages is inefficient in terms of both utilization and development. Therefore, a printer driver capable of supporting multiple printer description languages has been developed (for example, Japanese Patent Application Laid-open No. 2009-053789).

In Japanese Patent Application Laid-open No. 2009-053789, to deal with the diversity in the function of print settings, an information processing apparatus has been proposed that stores multiple types of PDLs in advance in a storage unit and selects, from the storage unit, a PDL that is executable of the function of print settings entered by a user to convert print data and print settings to the selected PDL.

However, in the technology disclosed in Japanese Patent Application Laid-open No. 2009-053789, while a suitable PDL for the function of print settings entered by the user can be selected and the job commands that describe the print settings can be generated, no commands can be generated without relying on the types and the specifications of the commands.

### SUMMARY OF THE INVENTION

It is an object of the present invention to at least partially solve the problems in the conventional technology.

According to an aspect of the present invention, an information processing apparatus, includes: an obtaining unit that obtains a specification of commands to output to a printer; a receiving unit that receives a request for a process to be executed for the printer; a generating unit that generates a predetermined command corresponding to a type of the request and the specification obtained when the request is received; and an output unit that outputs to the printer the command generated for each of the request.

According to another aspect of the preset invention a computer program product including a non-transitory computer-usable medium having computer-readable program codes embodied in the medium, the program codes when executed causing a computer to execute: obtaining a specification of commands to output to a printer; receiving a request for a process to be executed for the printer; generating a predetermined command corresponding to a type of the request and the specification obtained when the request is received; and outputting to the printer the command generated for each of the request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an overall structure of a printer system according to a first embodiment of the present invention;

FIG. 2 is a block diagram illustrating the structure of an information processing apparatus 100;

FIG. 3 is a diagram for explaining an exemplary request sent to a printer 150 at the every given timing;

FIG. 4 is a block diagram illustrating the structure of a generating unit 115;

FIG. 5 is a diagram for explaining an exemplary structure of commands;

FIG. 6 is a diagram for explaining exemplary commands generated at the every timing of receiving each request;

FIG. 7 is a diagram for explaining concrete examples of commands generated at the every timing of receiving each request;

FIG. 8 is a flowchart indicating a procedure of command generating process performed by the information processing apparatus 100;

FIG. 9 is a diagram for explaining exemplary printers 150a, 150b, and 150c each set with job commands and drawing commands of different specifications;

FIG. 10 is a diagram illustrating an exemplary command specification select screen that receives the selection of a user;

FIG. 11 is a block diagram illustrating the structure of a generating unit 215; and

FIG. 12 is a diagram illustrating the hardware structure of the information processing apparatus 100.

### DETAILED DESCRIPTION OF THE PREFERRED EMBODIMENTS

Exemplary embodiments of an information processing apparatus, a print control program, and a recording medium according to the present invention will be explained in detail with reference to the accompanying drawings below.

### First Embodiment

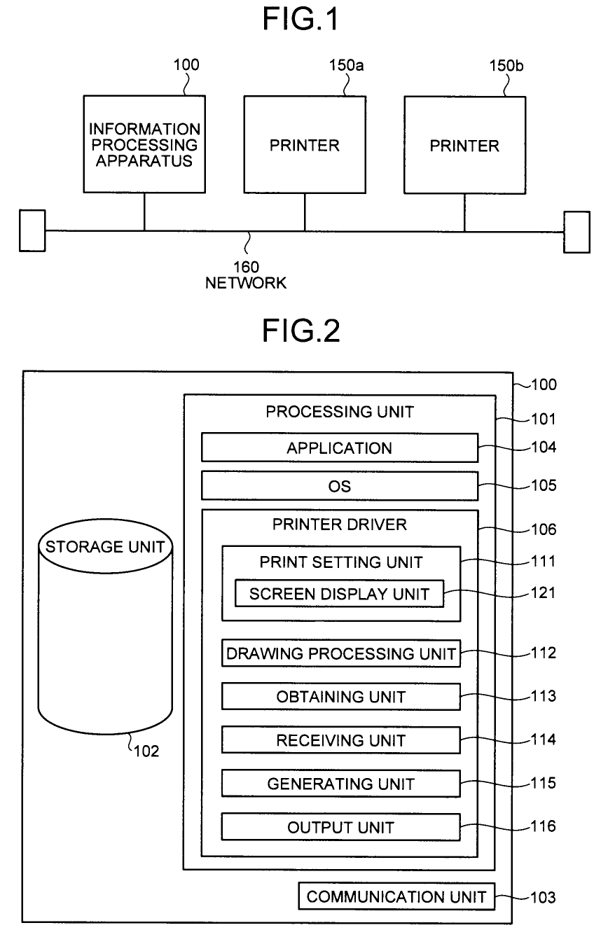

FIG. 1 is a diagram illustrating an overall structure of a printer system according to a first embodiment of the invention. As depicted in FIG. 1, in the first embodiment, an information processing apparatus 100 and the printers 150a and 150b (hereinafter, collectively referred to as a printer 150) are connected with one another via a network 160. The number of the printer 150 may be more than one as depicted in FIG. 1 or may only be one. The information processing apparatus 100 sends a print request to the printer 150 via the network 160, and upon receiving the print request the printer 150 carries out a printing process.

FIG. 2 is a block diagram illustrating the structure of the information processing apparatus 100. As depicted in FIG. 2, the information processing apparatus 100 includes a processing unit 101, a storage unit 102, and a communication unit 103. The processing unit 101 is structured to include a central processing unit (CPU) (not depicted) as a control unit and a group of memories having a ROM and a RAM as a main memory. When the information processing apparatus 100 is starting up or executing, an application 104, an operating system (OS) 105, and various drivers (only a printer driver 106 is depicted in FIG. 2) are loaded from the ROM and the storage unit 102 and extracted in the main memory, and are executed by the CPU.

Although the information processing apparatus 100 has a hardware structure utilizing a typical computer provided with input devices such as a keyboard and a mouse and output devices such as a display, they are omitted in FIG. 2 for the sake of simplifying the explanation.

The application 104 is software to which a user can give a print instruction. The application 104 receives the print instruction from the user. The application 104 alone does not generate print data for the printer 150, but delivers to the OS 105 the information of a print subject together with a print request corresponding to the print instruction.

The OS 105 is a program that controls the hardware and software of the information processing apparatus 100. The OS 105 carries out the controls of starting up a program, reading and storing of information, and the like.

The storage unit 102 stores therein specifications corresponding to the printer 150. For example, the storage unit 102 stores therein the specifications of job commands such as PJL and JDF, and the specifications of drawing commands such as PCL, Post Script, and RPCS.

The printer driver 106 primarily includes a print setting unit 111, a drawing processing unit 112, an obtaining unit 113, a receiving unit 114, a generating unit 115, and an output unit 116. As depicted in FIG. 2, the print setting unit 111 is provided with a screen display unit 121.

The print setting unit 111 controls a UI displayed in the screen display unit 121. The screen display unit 121 controls the display of a GUI (print setting screen) displayed on a monitor screen as the UI. The screen display unit 121 receives an entry of print settings and changes in the currently set print settings by the user through the GUI.

The drawing processing unit 112 receives the information of print settings from the print setting unit 111 and carries out the processes other than generating commands in response to the information of the print settings received. For example, the drawing processing unit 112 carries out the process to a drawing object such as magnification, reduction, rotation, and color reduction.

The obtaining unit 113 obtains job commands and drawing commands of specifications of the printer 150 connected via the network 160 by the communication unit 103.

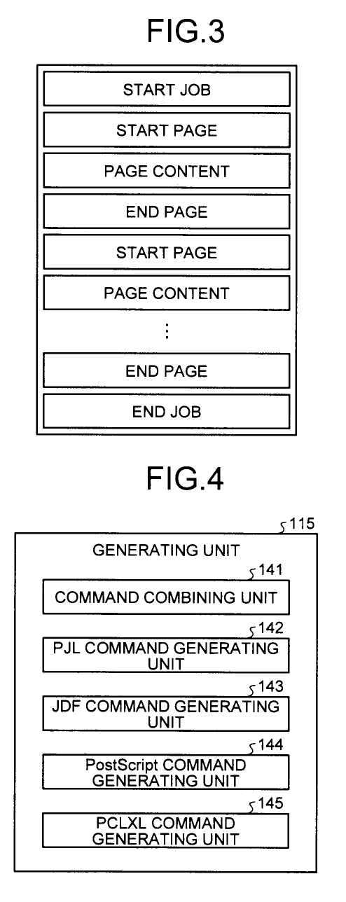

The receiving unit 114 receives a request for print process sent from the OS 105 to the printer 150 at each of the timing. FIG. 3 is a diagram for explaining an exemplary request for print process sent to the printer 150 at the every timing. As depicted in FIG. 3, the request for print process includes a start job request, a start page request, a page content request, an end page request, and an end job request. The start job request is a request to start a process in a job unit, while the start page request is a request to start a process in a page unit, the page content request is a request to send drawing information in a page, the end page request is a request to end a process in a page unit, and the end job request is a request to end a process in a job unit.

The generating unit 115 generates a predetermined command for each request in response to the job commands and the drawing commands obtained by the obtaining unit 113 and the request for print process received by the receiving unit 114. The generating unit 115 may generate commands by the job commands and the drawing commands selected by the user besides the job commands and the drawing commands obtained by the obtaining unit 113.

The generating unit 115 includes a plurality of command generating units corresponding to the specifications of job commands and drawing commands. FIG. 4 is a block diagram illustrating the structure of the generating unit 115. As depicted in FIG. 4, the generating unit 115 mainly includes a command combining unit 141, a PJL command generating unit 142, a JDF command generating unit 143, a Post Script command generating unit 144, and a PCLXL command generating unit 145.

The command combining unit 141 combines all commands generated into one when more than one command is generated. Furthermore, the command combining unit 141 determines the order of generation when the command to be generated is more than one.

The PJL command generating unit 142, the JDF command generating unit 143, the Post Script command generating unit 144, and the PCLXL command generating unit 145 (hereinafter, referred to as each command generating unit, unless otherwise expressed specifically) generate, at the timing of receiving their respective requests, the job commands and the drawing commands according to the information such as grammar and rules of the specifications required for generating commands sent to the printer. Each command generating unit may be provided separately as a physical package.

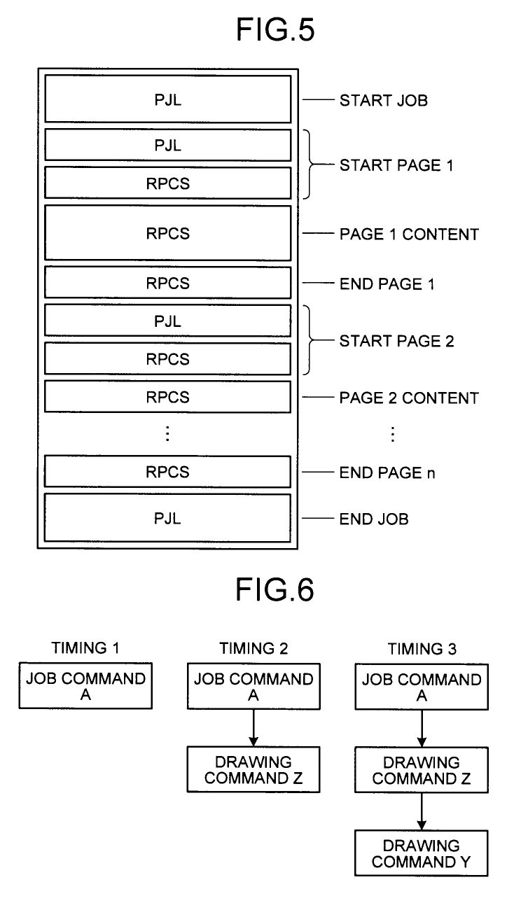

FIG. 5 is a diagram for explaining an exemplary structure of commands. As depicted in FIG. 5, each command generating unit generates a PJL command as the job command at the timing of receiving the start job request, while generating an RPCS command as the drawing command at the timing of receiving the page content request or the end page request and generating a PJL command as the job command at the timing of receiving the end job request. Furthermore, the various generating units generate a PJL command as the job command and an RPCS command as the drawing command at the timing of receiving the start page request.

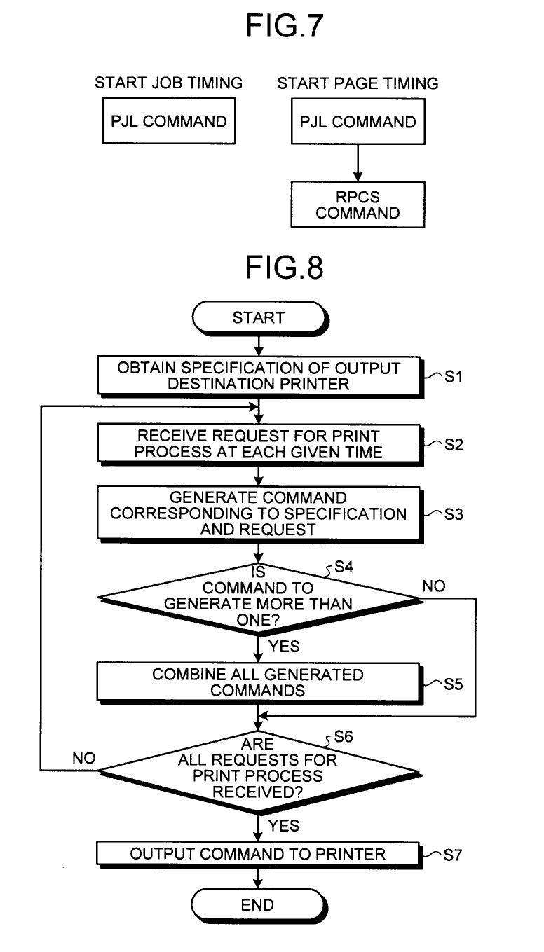

Accordingly, the type of commands generated at the timing of receiving a request is not limited to one type, but the type of commands may be more than one. FIG. 6 is a diagram for explaining examples of commands generated at the every timing of receiving each request. As depicted in FIG. 6, the generating unit 115 generates a job command A at a timing 1, while generating the job command A and a drawing command Z at a timing 2; and generating the job command A, the drawing command Z, and a drawing command Y at a timing 3. More specifically, as illustrated in FIG. 7, at the timing of start job when a start job request is received, the generating unit 115 generates only a PJL command as the job command; and at the timing of start page when a start page request is received, the generating unit 115 generates a PJL command as the job command and an RPCS command as the drawing command. Meanwhile, depending on the request, it may not be necessary to output any commands. In this case, the generating unit 115 generates no commands even when the request is received.

The output unit 116 outputs the commands generated by the generating unit 115 to the printer 150 connected with the information processing apparatus 100 via the communication unit 103.

The communication unit 103 sends and receives information to and from the printer 150 connected via the network 160.

A procedure of the command generating process performed by the information processing apparatus 100 thus structured will be described. FIG. 8 is a flowchart indicating the procedure of the command generating process carried out by the information processing apparatus 100.

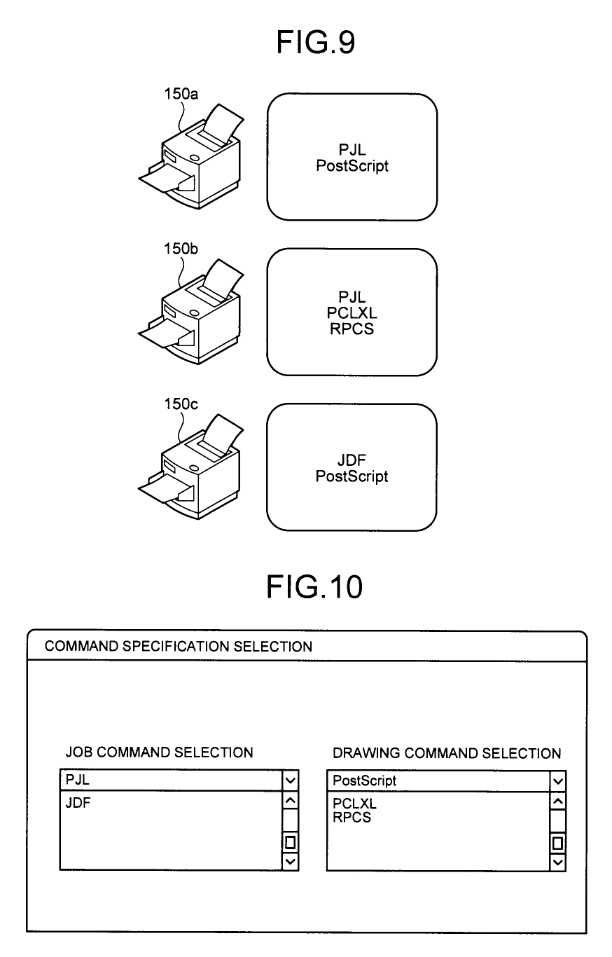

The obtaining unit 113 obtains the specifications set for the printer of output destination (Step S1). The specifications of job commands and drawing commands are obtained here. For example, FIG. 9 is a diagram for explaining an example of printers 150a, 150b, and 150c to which separate specifications are set. As indicated in FIG. 9, the printer 150a is installed with the PDL as the specification of job commands and the Post Script as the specification of drawing commands; while the printer 150b is installed with the PJL as the specification of job commands and PCLXL and the RPCS as the specifications of drawing commands; and the printer 150c is installed with the JDF as the specification of job commands and the Post Script as the specification of drawing commands. The obtaining unit 113 obtains the respective specifications of job commands and drawing commands installed from the printer 150 connected with the information processing apparatus 100 or selected printer 150.

The obtaining unit 113 may obtain the job commands and the drawing commands selected by the user. FIG. 10 is a diagram illustrating an exemplary command specification select screen that receives the selection of the user. As depicted in FIG. 10, the print setting unit 111 displays a select screen displaying multiple specifications of job commands and drawing commands in the screen display unit 121, and receives the selection of the job commands and the drawing commands by the user.

The receiving unit 114 receives a request for print process from the OS 105 for the every timing (Step S2). The generating unit 115 generates commands corresponding to the job commands and the drawing commands of the specifications obtained and the request (Step S3). The generating unit 115 generates commands by the PJL command generating unit 142, the JDF command generating unit 143, the Post Script command generating unit 144, and the PCLXL command generating unit 145 depicted in FIG. 4. The specifications of job commands and drawing commands generated by the generating unit 115 can be added, deleted, or replaced.

Other examples of generating units will be described below. For example, a generating unit 215 installed in a

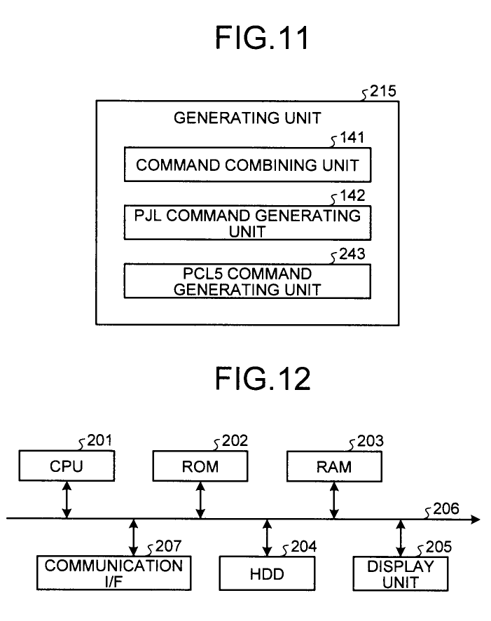

PCL5 driver will be explained. FIG. 11 is a block diagram illustrating the structure of the generating unit 215. As depicted in FIG. 11, the generating unit 215 may be structured to include the command combining unit 141, the PJL command generating unit 142, and a PCL5 command generating unit 243. The PCL5 command generating unit 243 generates PCL5 commands corresponding to the specification of the PCL5 driver. The PCL5 command generating unit 243 has a filter structure with a plurality of job commands and drawing commands are combined; therefore a PJL command generating unit of an existing PCLXL driver may be a substitute for the PCL5 command generating unit 243. In this case, the PCL5 command generating unit 243 can generate both the PJL commands and the PCL5 commands in response to the timing of the request received. Furthermore, in the PCLXL driver, the drawing commands are generated in a drawing processing unit (not depicted), while the PJL commands are generated in a generating unit (not depicted).

As another example of a generating unit, a generating unit installed in an RPCS driver will be described. In the RPCS driver, a drawing processing unit (not depicted) generates drawing commands, while a generating unit (not depicted) generates intermediate commands. The generating unit installed in the RPCS driver is not structured to generate commands to be sent to the printer 150, but is structured to generate an internally generated intermediate language. Even in this case, the generating unit can generate predetermined commands for the requests.

The generating unit 115 determines whether the command to generate for the request received from the receiving unit 114 is more than one command (Step S4). For example, as explained with reference to FIG. 7, as the command to generate for the start job request, only a PJL command is predetermined. Meanwhile, as the command to generate for the start page request, two commands including a PJL command and an RPCS command are predetermined.

When the command to generate is more than one (Yes at Step S4), the generating unit 115 combines all the commands generated into one (Step S5). When all the commands are combined into one by the generating unit 115 or when the command to generate by the generating unit 115 is determined to be only one (No at Step S4), the output unit 116 determines whether all requests for print process are received (Step S6). When determining all the requests for print process are received (Yes at Step S6), the output unit 116 outputs the commands to the printer 150 (Step S7). Meanwhile, if the output unit 116 determines that not all requests for print process have been received yet (No at Step S6), the procedure returns to Step S2 and the processes from Step S2 to Step S6 are repeated.

In the flowchart indicated in FIG. 8, while the commands are output to the printer at Step S7 after all the requests for print process are received at Step S6, the commands may be output to the printer every time a command is generated corresponding to the request for print process, and thereafter it may be determined whether all the requests for print process are received.

As described in the foregoing, according to the present embodiment, the job commands and the drawing commands of the specifications set in the printer 150 are obtained from the printer 150 connected and, for every request for print process, the commands are generated corresponding to the job commands and the drawing commands obtained and the request for print process. This makes it possible for a single printer driver to generate commands for a printer of multiple specifications.

Furthermore, according to the present embodiment, the job commands and the drawing commands of the specifications selected by the user are obtained and, for each of the request for print process, the commands are generated corresponding to the job commands and the drawing commands obtained and the request for print process. This allows the commands to be generated with the job commands and the drawing commands corresponding to the demand of the user.

Furthermore, according to the present embodiment, commands are generated for every request for print process and, if there is a plurality of requests for print process, the commands generated with the job commands or the drawing commands of multiple specifications corresponding to each of the requests can be combined. This makes it possible to support printers of various specifications with a single printer driver.

The information processing apparatus 100 of the present embodiment includes, as depicted in FIG. 12, a CPU 201, a read only memory (ROM) 202, a RAM 203, a communication I/F 207 an HDD 204 as an external storage device, a display unit 205 such as a display device, and a bus 206 connecting the foregoing components, and thus has a hardware structure utilizing a typical computer.

A print control program executed by the information processing apparatus 100 of the present embodiment is provided in a file of an installable format or an executable format recorded on a computer readable recording medium such as a CD-ROM, a flexible disk (FD), a CD-R, and a digital versatile disk (DVD).

The print control program executed by the information processing apparatus 100 of the present embodiment may be provided by storing it on a computer connected to a network such as the Internet and downloading it via the network.

Furthermore, the print control program executed by the information processing apparatus 100 of the present embodiment may be provided or distributed via a network such as the Internet.

The print control program of the present embodiment may be provided embedded in advance in a ROM or the like.

The print control program executed by the information processing apparatus 100 of the present embodiment is in a modular structure including each of the foregoing units (the drawing processing unit 112, the obtaining unit 113, the receiving unit 114, the generating unit 115, and the output unit 116). In the actual hardware, the CPU (processor) reads the print control program from the recording medium and executes it to make each of the units to be loaded in the main memory, and thus the drawing processing unit 112, the obtaining unit 113, the receiving unit 114, the generating unit 115, and the output unit 116 are provided in the main memory.

The present invention has an effect that commands can be generated without relying on the types and the specifications of the commands.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, comprising:
an obtaining unit that obtains a specification of commands to output to a printer;
a receiving unit that receives a request for a process to be executed for the printer;
a generating unit that generates a predetermined command corresponding to a type of the request and the specification obtained when the request is received; and
an output unit that outputs to the printer the command generated for each of the request.

2. The information processing apparatus according to claim 1, wherein
the obtaining unit obtains a plurality of specifications of commands to output to a printer, and
the generating unit generates for each type of the request a predetermined command corresponding to the type of the request and the specifications obtained.

3. The information processing apparatus according to claim 1, wherein
the receiving unit receives at least one of a request for a process in a job unit and a request for a process in a page unit, and
the generating unit generates a predetermined job command that describes content of the process in a job unit corresponding to the specification obtained when the request for a process in a job unit is received and generates a predetermined drawing command that describes content of the process in a page unit corresponding to the specification obtained when the request for a process in a page unit is received.

4. The information processing apparatus according to claim 3, wherein
the receiving unit receives a request to start job or a request to end job, and
the generating unit generates the job command predetermined corresponding to the specification obtained when the request to start job or the request to end job is received.

5. The information processing apparatus according to claim 3, wherein
the receiving unit receives a request for a process to describe a page or a request to end a process in a page unit, and
the generating unit generates the drawing command predetermined corresponding to the specification obtained when the request for a process to describe a page or the request to end a process in a page unit is received.

6. The information processing apparatus according to claim 3, wherein
the receiving unit receives a request to start a process in a page unit, and
the generating unit generates the job command and the drawing command predetermined corresponding to the specification obtained when the request to start a process in a page unit is received.

7. The information processing apparatus according to claim 1, wherein
the obtaining unit obtains from a connected printer the specification set for the printer.

8. A computer program product comprising a non-transitory computer-usable medium having computer-readable program codes embodied in the medium, the program codes when executed causing a computer to execute:
obtaining a specification of commands to output to a printer;
receiving a request for a process to be executed for the printer;
generating a predetermined command corresponding to a type of the request and the specification obtained when the request is received; and
outputting to the printer the command generated for each of the request.

9. The computer program product according to claim 8, causing the computer to further execute
obtaining a plurality of specifications of commands to output to a printer, and
generating for each type of the request a predetermined command corresponding to the type of the request and the specifications obtained.

10. The computer program product according to claim 8, causing the computer to further execute
receiving at least one of a request for a process in a job unit and a request for a process in a page unit, and
generating a predetermined job command that describes content of the process in a job unit corresponding to the specification obtained when the request for a process in a job unit is received and generates a predetermined drawing command that describes content of the process in a page unit corresponding to the specification obtained when the request for a process in a page unit is received.

11. The computer program product according to claim 10, causing the computer to further execute
receiving a request to start job or a request to end job, and
generating the job command predetermined corresponding to the specification obtained when the request to start job or the request to end job is received.

12. The computer program product according to claim 10, causing the computer to further execute
receiving a request for a process to describe a page or a request to end a process in a page unit, and
generating the drawing command predetermined corresponding to the specification obtained when the request for a process to describe a page or the request to end a process in a page unit is received.

13. The computer program product according to claim 10, causing the computer to further execute
receiving a request to start a process in a page unit, and
generating the job command and the drawing command predetermined corresponding to the specification obtained when the request to start a process in a page unit is received.

14. The computer program product according to claim 8, causing the computer to further execute
obtaining from a connected printer the specification set for the printer.
